(19) United States
(12) Patent Application Publication
(10) Pub. No.: US 2026/0015061 A1
(43) Pub. Date: Jan. 15, 2026

(54) Bicycle Frame and Bicycle

(71) Applicant: Canyon Bicycles GmbH, Koblenz (DE)

(72) Inventor: Marcelo Mader, Koblenz (DE)

(21) Appl. No.: 19/266,272

(22) Filed: Jul. 11, 2025

(30) Foreign Application Priority Data
Jul. 12, 2024 (DE) 20 2024 103 892.4

(51) Int. Cl. B62K 25/28

(52) U.S. Cl. CPC B62K 25/286

(57) ABSTRACT

The invention relates to a bicycle frame with a main frame, a rear frame displaceable relative to the main frame about a pivot point, and a pivot joint forming the pivot point, wherein the pivot joint is displaceable to change the position of the pivot point. The invention also relates to a bicycle with such a bicycle frame.

### CROSS-REFERENCE TO RELATED APPLICATION

This application claims priority to German Patent Application No. 20 2024 103 892.4 filed Jul. 12, 2024, the disclosure of which is hereby incorporated by reference in its entirety.

### BACKGROUND OF THE INVENTION

### Field of the Invention

The invention relates to a bicycle frame and a bicycle.

### Description of Related Art

Known full-suspension mountain bikes use various bicycle frames with suspension, such as single-pivot, four-pivot or Virtual Pivot Point (VPP) systems. Although these frame types offer effective shock absorption and improved traction, squat can occur which may lead to problems. Squat occurs when the force exerted on the rear frame when pedaling compresses the same and thus reduces the efficiency of propulsion. This leads to a loss of energy, for example, and can have a negative impact on the driving experience.

The concept of the anti-squat exists to prevent undesirable effects of the squat. For example, the kinematics and/or geometry of the suspension system is designed such that the pedal forces stabilize the rear frame instead of compressing the same. The anti-squat is influenced, for example, by adjusting the damper characteristics of the spring and/or by the pivot point position, in particular the positioning of the pivot point relative to the chain line.

Disadvantages of existing anti-squat concepts arise in the adjustment of the anti-squat to the needs of the rider and/or the driving situation. For example, it is possible that the anti-squat cannot be adapted or can only be adapted with difficulty or inaccurately.

### SUMMARY OF THE INVENTION

It is an object of the invention to provide a bicycle frame and a bicycle, in which the adaptability of the anti-squat is improved.

The object is achieved according to the invention with a bicycle frame as described herein and a bicycle as described herein.

The bicycle frame according to the invention is in particular a full-suspension bicycle frame. It is preferably a mountain bike frame. For example, the bicycle frame is a single-link frame, a four-link frame, in particular a Horst link frame, a dual-link frame, a six-link frame or a Virtual Pivot Point (VPP) frame. The bicycle frame has a main frame and a rear frame that can be moved relative to the main frame around a pivot point. In particular, the pivot point is a physical or virtual pivot point. Preferably, the pivot point corresponds to an axis of rotation, preferably a physical or virtual axis of rotation. The bicycle frame further comprises a pivot joint forming the pivot point. The pivot joint is preferably connected directly to the main frame, e.g. a seat tube of the main frame and/or directly to the rear frame, e.g. a chain stay of the rear frame. Preferably, the pivot joint is designed to allow the main frame and the rear frame to rotate relative to each other. It is preferred that the pivot joint has a degree of freedom of 1, which is in particular a rotational degree of freedom. The pivot joint can be moved to change the position of the pivot point and thus preferably to influence, particularly preferably to adjust the anti-squat. Advantageously, the anti-squat can be individualized by changing the position of the pivot point using the movable pivot joint, e.g. to the needs of the rider and/or with regard to the driving situation. In particular, the pivot joint can be moved and thus the position of the pivot point can be changed such that the moment exerted on the rear frame by a chain of a bicycle comprising the bicycle frame under pedaling load is changed and thus changes the anti-squat of the bicycle. Preferably, the pivot joint can be moved, and thus in particular the position of the pivot point can be changed, in such a way that this has no significant effect on the static geometry, preferably in the unloaded state, e.g. at 0% suspension travel, of the bicycle and/or this does not or only slightly affect the curve of the suspension travel and/or the movement ratio of the bicycle.

In addition to the adjustable anti-squat, the adjustable pivot joint, and thus the changeable position of the pivot point. makes it particularly advantageous to adapt the anti-squat to different chainring sizes, preferably to keep it consistent across different chainring sizes. In particular, the pivot joint and/or the pivot point can be displaced translationally in a range from 1 mm to 100 mm, preferably from 3 to 50 mm, particularly preferably from 4 to 30 mm.

It is preferable that the pivot joint is translationally displaceable. In particular, the pivot joint can be displaced in a height direction of the bicycle frame.

It is preferable that the pivot joint is displaceable relative to the main frame, in particular translationally. Preferably, the pivot joint is displaceable in a direction of extension, in particular a longitudinal direction, of a seat tube of the bicycle frame. Preferably, the pivot joint can be displaced parallel to the seat tube.

It is preferable that the pivot joint can be fixed in various positions relative to the main frame, in particular translationally. Preferably, the pivot joint can be fixed in the various positions by means of a flip chip.

It is preferred that the pivot joint is, at least partially, displaceably mounted in the main frame. In particular, the swivel joint is displaceably mounted in a seat tube of the main frame.

It is preferable that the main frame has an opening, in particular a hole, for the displaceable mounting of the pivot joint. In particular, the opening accommodates an axis of rotation of the pivot joint. In particular, the diameter of the opening is larger than the diameter of the axis of rotation so that the axis of rotation can be displaced in the opening. The opening is preferably a slotted hole. The slotted hole extends in particular in the longitudinal direction of the seat tube and in particular parallel to the seat tube.

It is preferred that the pivot joint has an axis of rotation, wherein the axis of rotation is displaceable. The displaceability of the pivot joint according to the invention is implemented in particular by a displaceability of the axis of rotation. The axis of rotation is preferably a physical axis of rotation, preferably a pin. In particular, the axis of rotation forms the pivot point. Preferably, the rear frame rotates around the pivot axis. It is preferable that the pivot point is congruent with an axis of rotation. The axis of rotation, in particular the pin, is arranged in the main frame so that it can be displaced. Preferably, the axis of rotation extends through the main frame, in particular completely. In particular, the pivot axis is connected to the main frame in a non-rotatable manner. In particular, the pivot joint further comprises at least one bearing, preferably a roller bearing. The bearing is preferably connected on one side, e.g. by an inner race of the bearing, to the pivot axis and on the other side, e.g. by an outer race of the bearing, to the rear frame, in particular the chain stay. It is preferred that the bearing enables rotation between the main frame and rear frame to implement the relative mobility between the main frame and rear frame.

It is preferred that the pivot joint is the main pivot joint, also called the main pivot, of the bicycle frame and/or that the pivot point is the main pivot point of the bicycle frame.

It is preferred that the distance between the pivot point and a bottom bracket axle of the bicycle frame changes when the pivot joint is displaced. In particular, the pivot joint is designed to be displaceable such that the distance between the pivot point and the bottom bracket axis of the bicycle frame changes when the pivot joint is displaced.

It is preferred that the pivot joint can be moved along a straight line that runs through a bottom bracket of the bicycle frame, in particular a bottom bracket axle of the bottom bracket.

It is preferred that the pivot joint is displaceable in two different positions or in more than two different positions. It is possible for the pivot joint to be infinitely or gradually displaceable, in particular between two positions.

It is preferred that the bicycle frame also has a flip chip, preferably in the main frame, particularly preferably in the seat tube, for displacing the pivot joint. The flip chip is preferably designed as an insert, in particular for insertion into the main frame. The flip chip is designed to translationally fix the pivot joint in various positions, preferably relative to the main frame, and preferably to fix it on and/or in the main frame. The flip chip according to the invention is in particular an eccentric spacer or an eccentric insert.

It is preferred that the flip chip is designed to arrange the axis of rotation of the pivot joint for changing the position of the pivot point in different positions relative to the main frame, preferably within the main frame. The flip chip is preferably designed to fix the axis of rotation translationally and/or rotationally on and/or in the main frame. In particular, the flip chip is designed to change the position of the pivot point using the adjustment function of the flip chip. Preferably, the flip chip is designed to displace the pivot joint using the adjustment function of the flip chip. In particular, the flip chip is designed to accommodate the preferably physical axis of rotation of the pivot joint in a displaceable manner. In particular, the adjustment function of the flip chip allows the axis of rotation of the pivot joint to be arranged in different positions to change the position of the pivot point. It is preferred that the flip chip is accommodated in the main frame, in particular in the opening of the main frame. The flip chip is preferably adjustable in the main frame, preferably in the opening of the main frame, e.g. rotatable and/or repositionable. In particular, the flip chip is a rotatable flip chip that can be rotated by 180°, for example, so that the rotation of the flip chip makes it possible to displace the pivot joint. In particular, the rotatable flip chip is a rotatable insert, preferably for insertion into the main frame. Preferably, the insert is configured to implement the displacement of the pivot joint by a relocation and/or inserted rotation of the pivot joint. On the other hand, or in addition, the flip chip may in particular be a relocatable flip chip. In particular, the displaceable flip chip has at least one plate that can be displaced into different positions in order to implement the displacement of the pivot joint in this way. On the other hand or in addition, the flip chip can be a reversible bushing. Furthermore, the flip chip can alternatively or additionally be a replaceable flip chip. In particular, the replaceable flip chip has various interchangeable inserts that can be removed and replaced by other chips with different position settings to implement the movement of the pivot joint.

In particular, the bicycle frame comprises a spring to cushion the movement between the main frame and the frame. In addition to the pivot joint, in particular the main pivot joint, the bicycle frame preferably comprises several secondary pivot joints to implement the mobility between the main frame and the rear frame.

The bicycle according to the invention is in particular a full-suspension mountain bike. The bicycle has a bicycle frame according to the invention. The pivot joint of the bicycle frame can in particular be displaced, and thus the position of the pivot point can be changed, such that the moment exerted on the rear frame by a chain the bicycle under pedaling load is changed and thus changes the anti-squat of the bicycle.

### BRIEF DESCRIPTION OF THE DRAWINGS

The terms FIG., FIGS., Figure, and Figures are used interchangeably in the specification to refer to the corresponding figures in the drawings.

In the following, the invention is described in more detail by means of preferred embodiments with reference to the accompanying drawings.

In the Figures:

FIG. 1 is a partial side view of an embodiment of a bicycle frame according to the invention,

FIG. 2 is a longitudinal sectional view of the pivot joint arranged in the seat tube in area II. in FIG. 1,

FIGS. 3-4 are perspective detail views in area II. in FIG. 1 in various states, and

FIG. 5 is a graph showing the anti-squat for different sprockets in two positions of a pivot joint.

### DESCRIPTION OF THE INVENTION

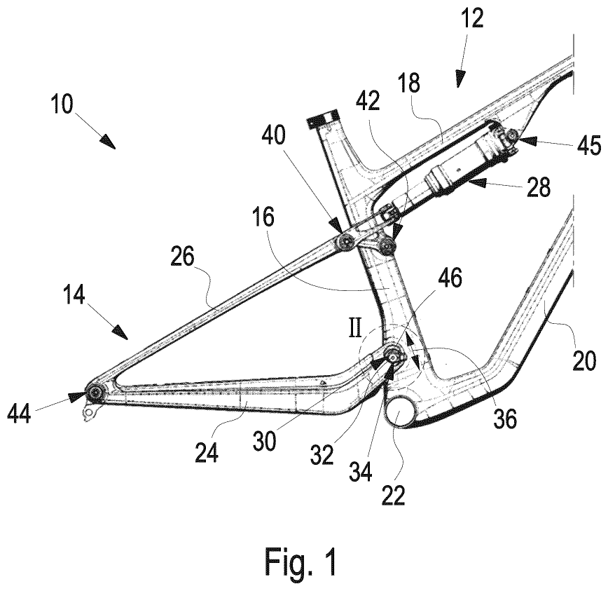

FIG. 1 shows a part of a bicycle frame 10 according to the invention with a main frame 12 and a rear frame 14.

The main frame 12 has a top tube 18, a seat tube 16 and a down tube 20.

By means of a main pivot joint 30, also called main pivot, connected to the main frame 12, with an axis of rotation 32, also called main axis of rotation, as well as four secondary pivot joints 40, 42, 44, 45, the rear frame 14 is designed to be rotatable relative to the main frame 12 about the main pivot point 34. In particular, the main pivot point 34 is congruent with the axis of rotation 32. In particular, the secondary swivel joints 40, 42, 44, 45 each have a secondary axis of rotation. To cushion the movement between the main frame 12 and the rear frame 14, the bicycle frame 10 has a spring 28 arranged between the top tube 18 and the seat stay 26 of the rear frame 14.

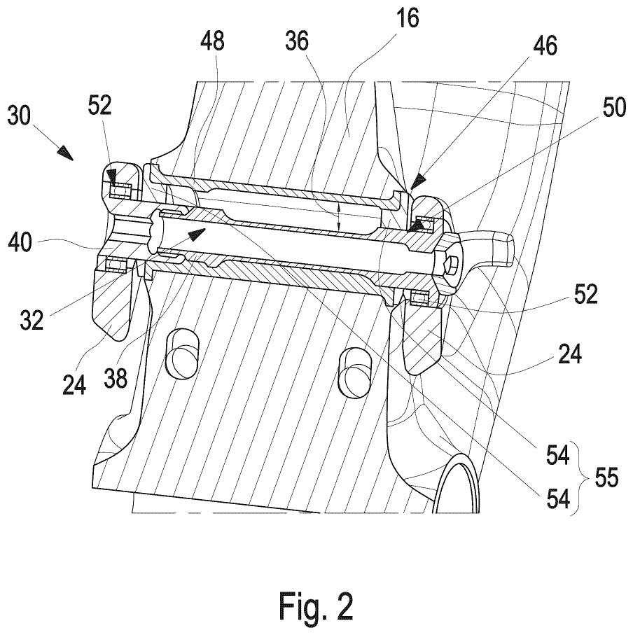

The main pivot joint 30 is arranged in an opening 46 (see FIG. 2) in the seat tube 16, which is preferably designed as a hole in the seat tube 46 of the main frame 12, and on the other hand is rotatably connected to the chain stay 24 of the rear frame 14 in order to implement the mobility. In this case, the main pivot joint 30 can be displaced translationally (shown by arrow 46) within the opening 46, preferably in a height direction of the bicycle frame 10 and/or in the direction of extension of the seat tube 16.

As can be seen in FIG. 2, the axis of rotation 32, which comprises a screw-connected axle body 38 and an axle nut 40, is arranged displaceably within the opening 46, in particular due to the opening 46 having a larger diameter than the axis of rotation 32. In particular, the opening 46 is a slotted hole for displaceably receiving the axis of rotation 32.

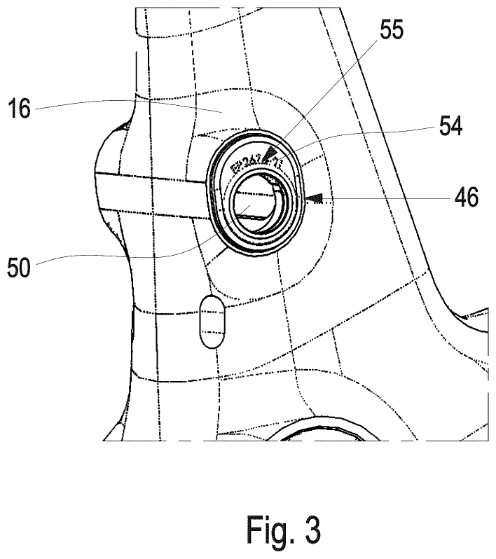

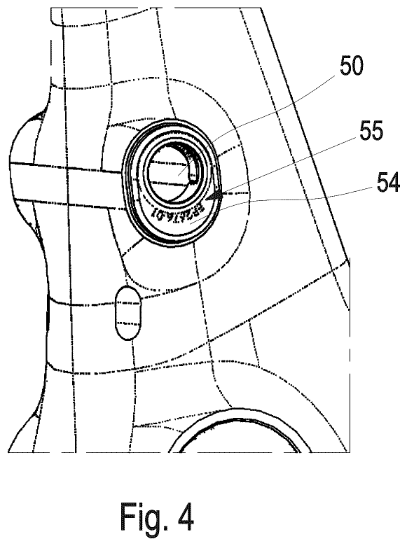

FIG. 2 shows an arrangement of the axis of rotation 32 in a first, in particular lower, position, wherein the axis of rotation 32 (along arrow 46) can be displaced upwards. To implement the displaceability and, in particular, translational fixing in various mounting positions, a flip chip 55 having two flip chip elements 54 is inserted into the opening 46, which has an axis receptacle 50, in particular in the form of an opening, for receiving the axis of rotation 32 (see FIGS. 3-4).

As shown, it is possible that the flip chip 55 is inserted into the opening 46 via a pivot bushing 48. On the other hand, it is also possible, for example, to insert the flip chip 55 directly into the opening and/or to connect it with the main frame 12. The movement between the main frame 12 and the rear frame 14 is implemented via two roller bearings 52 arranged between the pivot axle 32 and the chain stay 24.

FIG. 3 shows the flip chip 55 of FIG. 2 with the axis of rotation 32 hidden, in particular with the main pivot joint 30 hidden. The flip chip 55 is located in the position shown in FIG. 2, so that an arrangement of the axis of rotation 32 in the lower position is implemented via the axis holder 50.

The flip chip 55 can be adjusted, preferably rotated and/or relocated, in order to move the axis of rotation 32 and thus in particular the pivot joint 30. FIG. 4 shows an arrangement of the flip chip 55 in a second, upper position. By this adjustment of the flip chip 55, the axis of rotation 32, and thus in particular the main pivot joint 30, can be displaced into a second position (see arrow 46 in FIGS. 1-2).

By moving the axis of rotation 32, the pivot point 34 is displaced, in particular translationally (see FIG. 1). This changes the distance between the pivot point 34 and a bottom bracket axle of a bottom bracket (not shown), which is to be accommodated in the bottom bracket housing 22 of the bicycle frame. This change in distance makes the anti-squat particularly adaptable, wherein it is preferred that this change has no significant effect on the static geometry of the bicycle, preferably in the unloaded state, e.g. at 0% suspension travel, and/or that this has no or only a minor effect on the curve of the suspension travel and/or the movement ratio of the bicycle. It is implemented, for example, that the axis of rotation 32 and/or the main pivot joint 30 can be moved by 20 mm from the lower position (according to FIG. 3) to the upper position (according to FIG. 4). On the other hand (not shown) a displaceability is possible, for example, from 1 mm to 100 mm, preferably from 3 to 50 mm, particularly preferably from 4 to 30 mm.

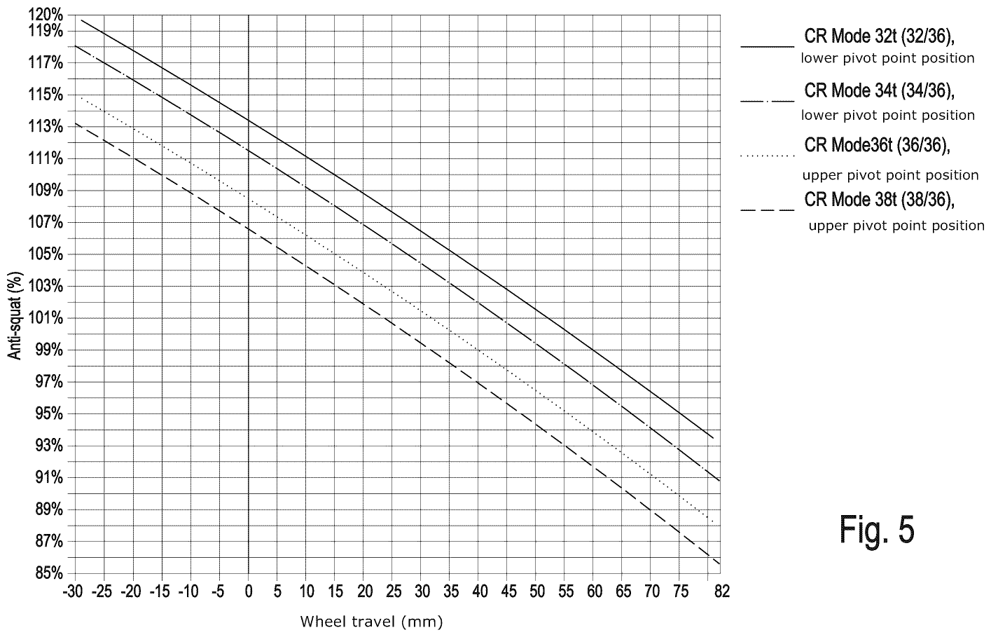

FIG. 5 shows a graph illustrating the anti-squat (in %) in relation to the vertical wheel travel (in mm) for different sprockets in the two positions of the pivot joint 32 shown in FIGS. 3 and 4. The wheel travel of 0 refers to the riding height of the bicycle or the point known as the “SAG” point.

The top (solid) curve shows the anti-squat for a sprocket with a number of teeth of 32 (ratio 32/36), where the pivot joint 30, and thus the pivot point 34, is in the lower position, as shown in FIG. 3.

The second (chain-dotted) curve shows the anti-squat for a sprocket with a number of teeth of 34 (ratio 34/36), also in the lower position as shown in FIG. 3.

The third (dotted) curve shows the anti-squat for a sprocket with a number of teeth of 36 (ratio 36/36), where the pivot joint 30, and thus the pivot point 34, is in the lower position, as shown in FIG. 4.

The lowermost (dash) curve shows the anti-squat for a sprocket with a number of teeth of 38 (ratio 38/36), also in the lower position as shown in FIG. 4.

The graph shows the adaptability of the anti-squat, in particular with regard to different sprockets, as a result of the invention.

What is claimed is:

1. A bicycle frame, in particular a full-suspension bicycle frame, comprising
a main frame,
a rear frame movable relative to the main frame about a pivot point, and
a pivot joint forming the pivot point,
wherein the pivot joint is displaceable to change the position of the pivot point.

2. The bicycle frame according to claim 1, wherein the pivot joint is translationally displaceable.

3. The bicycle frame according to claim 1, wherein the pivot joint is displaceable relative to the main frame.

4. The bicycle frame according to claim 1, wherein the pivot joint can be fixed in various positions relative to the main frame, in particular translationally.

5. The bicycle frame according to claim 1, wherein the pivot joint is displaceably received in the main frame.

6. The bicycle frame according to claim 5, wherein the main frame has an opening, in particular a bore, for displaceably receiving the pivot joint.

7. The bicycle frame according to claim 1, wherein the pivot joint has an axis of rotation, wherein the axis of rotation is displaceable.

8. The bicycle frame according to claim 1, wherein the pivot joint is the main pivot joint of the bicycle frame and/or that the pivot point is the main pivot point of the bicycle frame.

9. The bicycle frame according to claim 1, wherein the distance between the pivot point and a bottom bracket axis of the bicycle frame changes as a result of the displacement of the pivot joint.

10. The bicycle frame according to claim 1, wherein the pivot joint is displaceable along a straight line which runs through a bottom bracket of the bicycle frame, in particular a bottom bracket axle of the bottom bracket.

11. The bicycle frame according to claim 1, wherein the pivot joint is displaceable to two different positions or to more than two different positions.

12. The bicycle frame according to claim 1, wherein the bicycle frame further comprises a flip chip, in particular in the main frame, for displacing the pivot joint.

13. The bicycle frame according to claim 12, wherein the flip chip is configured to arrange an axis of rotation of the pivot joint in different positions relative to the main frame for changing the position of the pivot point.

14. A bicycle, in particular a full-suspension mountain bike, comprising the bicycle frame according to claim 1.
